(19) United States
(12) Patent Application Publication
(10) Pub. No.: US 2007/0036164 A1
(43) Pub. Date: Feb. 15, 2007

(54) Digital gateway for education systems

(76) Inventors: Rolf Goehler, Schaumburg, IL (US); Paul Duda, West Chicago, IL (US); Jeffrey Scott Wyman, Kitchener (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/201,201

(22) Filed: Aug. 11, 2005

(51) Int. Cl. H04L 12/28

(52) U.S. Cl. 370/401

(57) ABSTRACT

A communications and IP network gateway interface unit is provided for use with educational systems in a classroom environment. The gateway interface is configured to communicate with an IP network, and includes a digital signal processing unit storing programs for processing encoded data signals received from the IP network to produce an enhanced audio output. The audio output can be coupled to a telephone interface and connection for telephony communication configured to produce a voice signal portion of the audio output. The gateway interface further includes ports for sending a program audio signal such as music to a set of speakers, and for receiving audio from a microphone. Interface ports for synchronizing a clock are also included, as well as call switches, message display boards, audio-visual displays, in-class computer terminals, and other devices used to enhance and secure the educational environment.

### CROSS-REFERENCE TO RELATED APPLICATIONS

None.

### FIELD OF THE INVENTION

The present invention relates generally to electronics and communications systems. More particularly, the present invention relates to interface hardware and a system for digital communications configured for use in schools.

### BACKGROUND OF THE INVENTION

Digital technology and web of communications capabilities provided by the Internet and systems of local area networks affords an increasingly diverse and multi-functional set of devices and systems that enhance the ability to communicate over networks and exchange data, including voice, audio, video, etc. One area where such technology has not yet been fully implemented is the classroom environment. Many of the devices in classroom, such as a clock, a telephone, a public address or intercom system, audio or visual tools for aiding teaching, and classroom computing terminals, are not efficiently coupled to a network or central device or system for streamlining and enhancing the use of these devices. Educational environments currently do not fully benefit from the use of enhanced information delivery systems, where digital technology and network-based systems are not fully integrated into the dissemination and transfer of knowledge which is the central component of teaching. Furthermore, in a typical classroom, usually only one teacher or source of information is used to relay educational materials to a batch of students, and the group as a whole does not benefit from a networked arrangement of information and data transfer.

Current educational environments utilize specific proprietary systems and devices for each component in a classroom, including a different communications platform for a classroom computer or workstation, intercom, clock, messaging board, call switches, and audio-visual multimedia devices. Each component generally has its own specific cables and has limited interoperability. There is no central controller or interface for controlling or accessing these components.

Another particular problem with classrooms for younger students is that young children often cannot properly hear a teacher due to their relatively undeveloped aural capabilities. Therefore, students often strain and have difficulty in hearing and comprehending what a teacher may be saying. This places added stress on the teacher and hinders optimum teaching.

There is a need therefore for a central, efficient communications interface and system that utilizes the various tools and devices in a classroom environment and effectively allows the students and teachers to benefit from a networked data and communications infrastructure.

### SUMMARY OF THE INVENTION

In accordance with one embodiment of the present invention, a communications and IP network gateway interface unit is provided, which can be used with educational systems in a classroom environment. The interface unit includes a network connection port configured to communicate with an IP network, a digital signal processing unit coupled to a central processing unit, and a memory unit coupled to the central processing unit and to the digital signal processing unit. The memory unit stores programmed instructions for the digital signal processing unit and central processing unit to process a data signal received from the IP network to produce audio, control, or data output. A telephone interface and connection for telephony communication is included in the gateway interface and is configured to produce a voice signal portion of the audio output. The gateway interface also includes a first port for sending a program audio signal portion of the audio output to a set of speakers, a second port for receiving audio from a microphone, and an interface port for synchronizing a clock. The gateway interface receives a feedback audio signal measured from the microphone and the programmed instructions instruct the digital signal processing unit to alter a power frequency distribution of the audio output to improve room acoustics. The programmed instructions further instruct the digital signal processing unit to apply adaptive filtering or echo cancellation to the audio output to enhance a sound quality of the audio output.

In accordance with another embodiment the present invention, a communications and IP network gateway system is provided, which can be used in a classroom environment. The system includes a gateway interface coupled to an IP network. The gateway interface includes a digital signal processing unit coupled to a central processing unit, and a memory unit coupled to the central processing unit and to the digital signal processing unit. The memory unit stores programmed instructions for the digital signal processing unit and central processing unit to process a data signal received from the IP network to produce an audio, control or data output. The system further includes a telephone interface and connection for telephony communication on the gateway interface configured to produce a voice signal portion of the audio output. The gateway interface also includes a first port for sending a program audio signal portion of the audio output to a set of speakers, a second port for receiving audio from a microphone, and an interface port for synchronizing a clock.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view illustrating a gateway interface coupling an IP network with a classroom according to one embodiment of the invention.

FIG. 2 is a schematic view of the gateway interface of FIG. 1 coupled to an arrangement of devices in a classroom.

FIG. 3 is a schematic view illustrating a gateway interface coupling an IP network, via a wireless connection, with a classroom according to another embodiment of the invention.

FIG. 4 is a schematic view of a gateway interface that is wirelessly coupled to an arrangement of devices in a classroom.

### DETAILED DESCRIPTION

The invention will now be described with reference to the drawing figures, in which like reference numerals refer to like parts throughout. An embodiment in accordance with the present invention provides a communications and IP network gateway interface unit and system for use with educational systems in a classroom environment. The gateway interface is configured to communicate with an IP network, and includes a digital signal processing unit storing programs for processing encoded data signals received from the IP network to produce an enhanced audio output. The audio output can be coupled to a telephone interface and connection for telephonic communication configured to produce a voice signal portion of the audio output. The gateway interface further includes ports for sending a program audio signal such as music to a set of speakers, and for receiving audio from a microphone. Interface ports for synchronizing a clock are also included, as well as call switches, message display boards, audio-visual displays, in-class computer terminals, and other devices used to enhance and secure the educational environment.

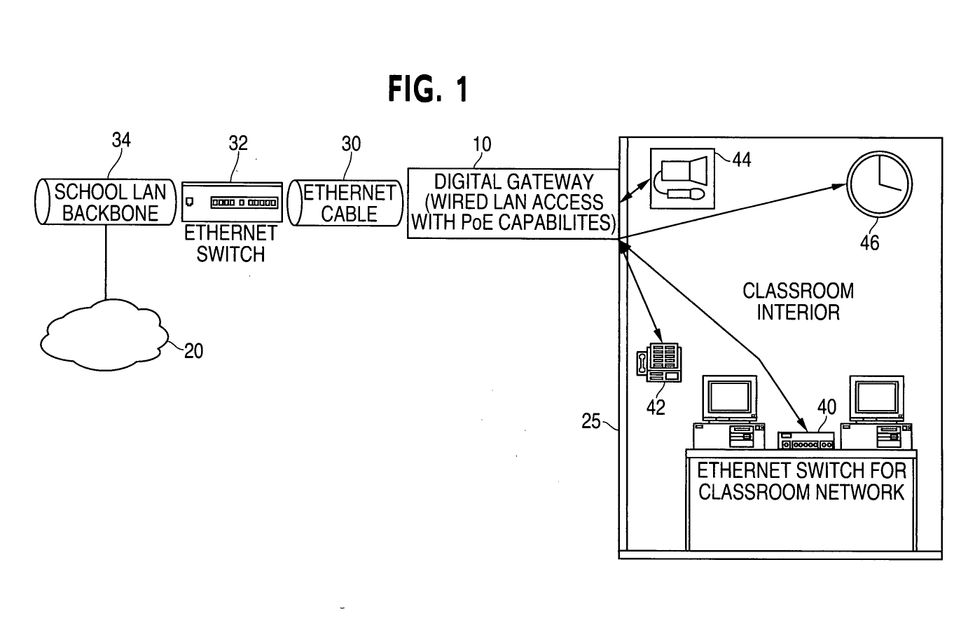

An embodiment of the present inventive apparatus is illustrated in FIG. 1. FIG. 1 is a schematic view illustrating a gateway interface 10 coupling an Internet Protocol (IP) network 20 with a classroom 25 according to one embodiment of the invention. The gateway 10 provides the interface means to convert digital control signals and digital encoded audio, such as for intercom signals, program audio like announcements and/or music, and other digital communications signals into more traditional output forms for room speakers, clocks, telephones, etc. The gateway 10 therefore acts like a bridge to the internet or LAN, enabling the use of traditional output devices and providing the final necessary analog output, where required.

Gateway 10 can be powered using the Power-over-Ethernet (PoE) standard which can be employed in the PoE compliant network switches. This power source can, in one example, provide 13 watts of power for use in certain functions of the gateway 10. The gateway 10 can connect to a standard IP network using a RJ45 connection port using the extra CAT5 wires for the PoE. As will be well known to those skilled in the art, any network connection port configured to communicate with an IP network is suitable and can be included in the gateway 10.

As illustrated in FIG. 1, one embodiment of the present inventive system and apparatus has a gateway interface unit 10 connected via an Ethernet cable 30 to an Ethernet switch 32, which is in turn connected to a Local Area Network (LAN) backbone 34, as may exist in any school building. The LAN backbone 34 would be connected to an IP network 20. Ethernet switch 32 can provide a wired connection to school network backbone 34 at a speed of at least 100 Mbps/1 Gbps, with the appropriate Ethernet cabling. The connection can carry data (under well-known control protocols such as SIP, SNMP, TCP/IP, UDP/IP, BOOTP, H.323, etc.), voice (under the well-known “Voice over IP” or VoIP encoding scheme such as ITU-T G.711, ITU-T G.722, etc), and video (such as MPEG (MPEG I, MPEG II or MPEG IV) or Windows Media encoded video data). All data and voice can be two way both to and from the gateway 10.

The digital gateway 10 can be configured for the classroom 25. And multiple gateways 10 can be provided in networked fashion across an entire school, facility, or campus. The gateway 10 provides services to the classroom 25 including an Ethernet switch 40 for in class network access, support for in class media such as viewing streaming media and VoIP access to a telephone 42, which provides two way communication capabilities to the classroom. The gateway also includes several circuits and ports for communicating with a voice or audio intercom system 44, which can include a speaker and/or microphone, which may be arranged together or separately at a location in the classroom 25. Element 44 may alternatively include a single unit which can function as both a microphone and speaker via electronic switching. A set of speakers may be used to broadcast music that is received through the IP network in encoded fashion and decoded into an audio signal by the gateway 10.

Gateway 10 can also include a connection port for connecting to digital or analog clocks 46, allowing for synchronization of the clocks and broadcast of scheduled time tones. The gateway 10 can make use of many of today's standards including VoIP encoding media, encoding such as MPEG and control standards such as SIP (Session Initiation Protocol) to be compliant with third party systems. The gateway 10 is also capable of supporting both wireless and wired networks and support PoE (Power over Ethernet IEEE 802.3af) that will allow the gateway 10 to be powered from the switch to which it is connected.

Gateway 10 includes an amplifier for amplifying the audio signal it produces. Gateway 10 further includes a digital signal processing unit coupled to a central processing unit. The central processing unit can be any microprocessor or microcontroller, or similar device. The gateway 10 further includes a memory unit coupled to the central processing unit and to the digital signal processing unit. The memory unit stores programmed instructions or software for the digital signal processing unit and central processing unit to process a data signal received from the IP network 20 to produce an audio output, which in turn can be received by the telephone 42, speakers 44, or any other transducer or sound producing device. The memory unit can be a flash type memory, or some other electronically erasable programmable read-only memory, as well as random access memory, for code execution and variables.

In particular, the gateway 10 can receive a feedback audio signal measured from a microphone 44 and the programmed instructions in the device can instruct the digital signal processing unit to alter a power frequency distribution of the audio output to improve room acoustics. For example, the programmed instructions can instruct the digital signal processing unit in the gateway 10 to apply adaptive filtering to the audio output to enhance a sound quality and intelligibility of the audio output. This is particularly useful for high reverberation environments such as is often found in old schools with high ceilings, wood floors, and plastered walls. Or, the programmed instructions can instruct the digital signal processing unit in the gateway 10 to apply echo cancellation to the audio output to enhance a sound quality of the audio output. The digital signal processing unit can further provide a greater bandwidth for audio output from the gateway 10 by using a higher sampling rate in the encoding and decoding of audio, such as music, that it receives and converts from the IP network 20. The bandwidth can be higher than the standard 4 kHz that is used for VoIP telephone communication using the standard ITU-T G.711, ITU-T G.726, etc. CODEC algorithms.

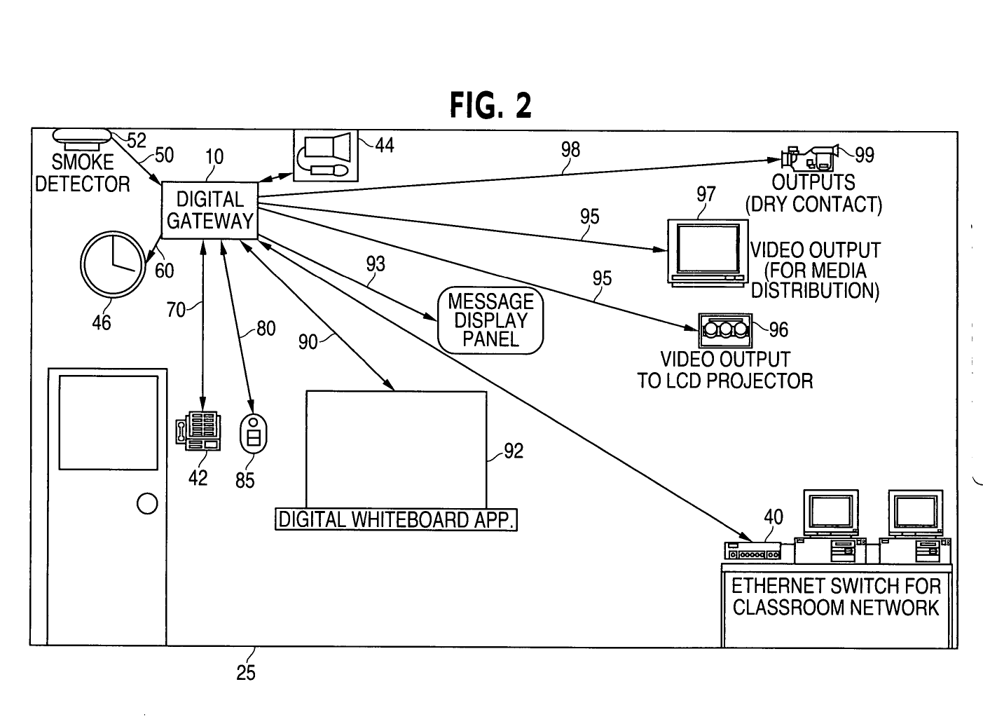

FIG. 2 is a schematic view of the gateway interface 10 of FIG. 1 coupled to an arrangement of devices in a classroom 25. Wired connection 50 can be used for secondary or supplementary interface to the fire alarm system 52, which connection would allow the gateway 10 to receive signals from the smoke detector 52 connected thereto but would not send information to the smoke detector 52. However, a two-way data exchange between the gateway 10 and smoke detector 52 is also contemplated, if a smoke detector is fitted with a smart data interface.

Wired connection 60 could be used to update analog or digital clocks 46. The gateway interface 10 can thereby provide contact closure or possibly a data stream that would update the clock 46 from a master clock source on the network.

Wired connection 70 can be used to connect to a telephone 42. Telephone 42 can be a standard 2500 DTMF telephone, which would receive from the gateway 10 a battery voltage, ringing and analog voice. The gateway 10 can provide typical subscriber line card services—DTMF interface, hookswitch status sense, etc. The gateway 10 acts as an IP telephone gateway hence providing the analog telephone with a gateway onto the IP network. The gateway 10 would have a telephone interface and connection for telephony communication configured to produce a voice signal portion of the audio output it produces, wherein the voice signal is decoded from a VoIP encoded data signal received over the IP network.

Gateway 10 can further have a wired connection 80 to both control and receive updates from a variety of call switches 85. When a button is pushed on the call switch 85, data would be sent to the gateway 10 and the gateway 10 would then send the data to the control application. The gateway 10 may send data to tell the call switch 85 to turn on an LED for in-class notification or other commands such as message waiting.

Another wired connection 90 can be made from the gateway 10 to a whiteboard type of device 92, which would allow students and teachers to interact without leaving their desks. Data transfer would be two-way to and from the gateway 10. Commands would be sent to the whiteboard 92 to draw etc. and data would be sent back from the whiteboard 92 with the current contents of the board to a device for storage or further processing, like a classroom PC.

There can also be a wired connection 93 for a message panel 94 type of device, which would display information received from the gateway 10. The message board 94 would also send information back to the gateway 10 in terms of status or board content. Additional wired connections 95 to an in class LCD projector 96 or video monitor 97 for display can be made. This would be used when distributing media to a classroom. This would be an output type of connection only and could provide analog video (NTSC, PAL or HD), or digital video. Finally, the system can include a wired connection 98 to outputs 99 of a dry contact isolated type. These could be used to trigger security cameras or other devices, which require a contact closure or open to trigger an action. This would be an output only.

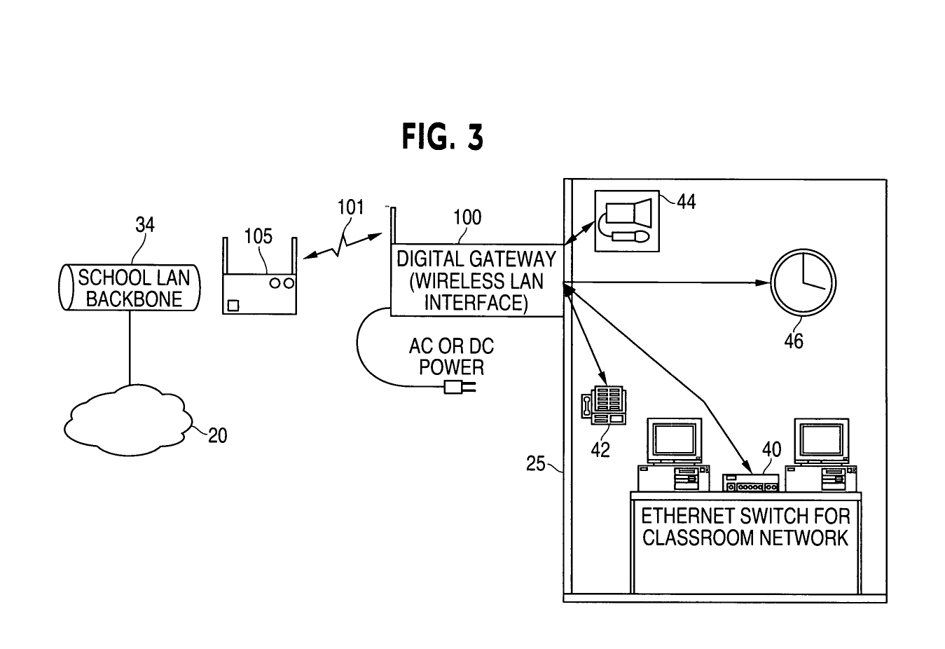

FIG. 3 is a schematic view illustrating another embodiment of gateway interface 100 coupling to an IP network 20, via a wireless connection 101, with a classroom 25 according to the principles of the present invention. Component 105 is a wireless access point that is connected to the school network backbone 34, and can support the wireless standards IEEE 802.11a/b/g etc. The wireless access point 105 can send and receive data, voice and video to the network backbone 34 and provide data, video and voice to the digital gateway 100 via a secure wireless connection. Speeds for the wireless connection would be dependent upon which wireless standard was being used at the time. Digital gateway 100 is identical to gateway 10 discussed above, except that is may have to rely on local AC or DC power instead of PoE, because it connects to the IP network 20 wirelessly.

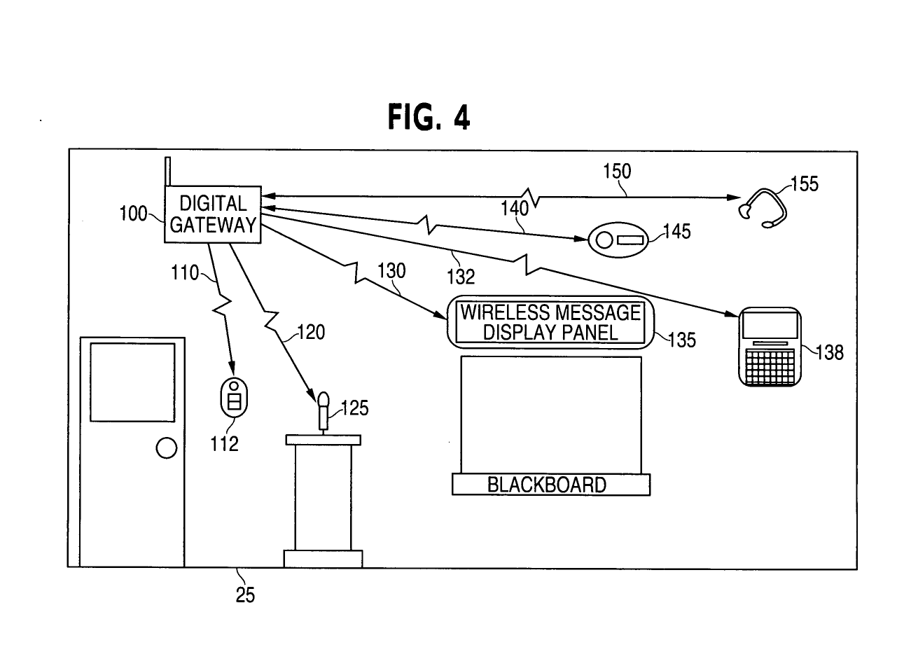

FIG. 4 is a schematic view of a gateway interface 100 that is wirelessly coupled to an arrangement of devices in a classroom. Gateway interface 100 is identical to gateway interface 100 in FIG. 3, except that it is now coupled to a number of devices within the classroom 25 via a plurality of wireless connections. This includes a wireless connection 110 which would both control and receive updates from a variety of call switches 112. The data could be a sent back to the gateway 100 over a wireless protocol such as Bluetooth (IEEE 802.15.1), Zigbee (IEEE 802.15.4) or IEEE 802.11a/b/g. When a button is pushed on the call switch 112 data would be sent to the gateway 100 and the gateway 100 would then send the data to the control application. The gateway 100 sends data to tell the call switch 112 to turn on an LED for in-class notification or other commands such as message waiting.

The system can also include a wireless connection 120 to a microphone 125 that would be used as an alternative input to the in class speaker(s). The wireless enabled microphone 125 would allow a teacher or speaker to amplify their voice using an amplifier in gateway 100 and the in class speaker(s). Additional wireless connections 130 and 132 could be used to connect to message panel devices 135 and handheld PDA devices 138, respectively. The message board 135 would also send information back to the gateway 100 in terms of status or board content. The delivery protocols used could be Bluetooth, Zigbee or IEEE 802.11a/b/g. The PDA 138 interface with the gateway 100 could be of an IEEE 802.11a/b/g, Bluetooth or Zigbee type depending on the PDA device. The data, voice or video would be two-way in nature and the PDA 138 could be used to send control commands to the gateway 100 or system for the control of media distribution, etc. The applications on this device include student attendance, room device(s) control, etc.

Another wireless connection 140 can be made to a badge device type 145. The interface with the gateway 100 could be an RF standard like RFID, Zigbee, Bluetooth, etc. The data could be two-way both commands sent from the gateway 100 to the device and commands and information sent from the device 145 to the gateway for applications such as: automatic student attendance, emergency call-in, etc.

Finally, a wireless connection 150 can be made to a Bluetooth enabled headset 155 that could be used by students for self-paced media learning. The interface would be two-way from the headset 155 to the gateway 100 and could contain audio or data (such as commands).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A communications and IP network gateway interface unit for use with educational systems in a classroom environment, comprising:
a network connection port configured to communicate with an IP network,
a digital signal processing unit coupled to a central processing unit,
a memory unit coupled to the central processing unit and to the digital signal processing unit, the memory unit storing programmed instructions for the digital signal processing unit and central processing unit to process a data signal received from the IP network to produce an audio, control, or data output,
a telephone interface and connection for telephony communication configured to produce a voice signal portion of the audio output,
a first port for sending a program audio signal portion of the audio output to a set of speakers,
a second port for receiving audio from a microphone, and
an interface port for synchronizing a clock.

2. The gateway interface of claim 1, wherein the gateway receives a feedback audio signal measured from the microphone and the programmed instructions instruct the digital signal processing unit to alter a power frequency distribution of the audio output to improve room acoustics.

3. The gateway interface of claim 1, wherein the programmed instructions instruct the digital signal processing unit to apply adaptive filtering to the audio output to enhance a sound quality of the audio output.

4. The gateway interface of claim 1, wherein the programmed instructions instruct the digital signal processing unit to apply echo cancellation to the audio output to enhance a sound quality of the audio output.

5. The gateway interface of claim 1, further comprising:
one or more multi-media ports for sending audio-visual signals received from the IP network to a display device.

6. The gateway interface of claim 1, further comprising:
one or more dry contact ports for coupling the gateway interface to one or more devices through one or more closed, electrically isolated connections.

7. The gateway interface of claim 1, further comprising:
one or more isolated input or output signal ports for coupling to one or more call switches.

8. The gateway interface unit of claim 1, wherein the gateway interface communicates with the one or more call switches through a wireless communications medium.

9. The gateway interface unit of claim 1, wherein the gateway interface communicates with the IP network through a wireless communications medium.

10. The gateway interface unit of claim 1, wherein the gateway interface communicates with the microphone through a wireless communications medium.

11. A communications and IP network gateway system for use in a classroom environment, comprising:
a gateway interface coupled to an IP network, having
a digital signal processing unit coupled to a central processing unit,
a memory unit coupled to the central processing unit and to the digital signal processing unit, the memory unit storing programmed instructions for the digital signal processing unit and central processing unit to process a data signal received from the IP network to produce an audio, control, or data output,
a telephone interface and connection for telephony communication configured to produce a voice signal portion of the audio output,
a first port for sending a program audio signal portion of the audio output to a set of speakers,
a second port for receiving audio from a microphone, and
an interface port for synchronizing a clock.

12. The system of claim 11, wherein the gateway interface receives a feedback audio signal measured from the microphone and the programmed instructions instruct the digital signal processing unit to alter a power frequency distribution of the audio output to improve room acoustics.

13. The gateway interface of claim 11, wherein the programmed instructions instruct the digital signal processing unit to apply adaptive filtering to the audio output to enhance a sound quality of the audio output.

14. The system of claim 11, wherein the programmed instructions instruct the digital signal processing unit to apply echo cancellation to the audio output to enhance a sound quality of the audio output.

15. The system of claim 11, further comprising:
one or more multi-media ports in the gateway interface for sending audio-visual signals received from the IP network to a display device.

16. The system of claim 11, further comprising:
one or more dry contact ports in the gateway interface for coupling the gateway interface to one or more devices through one or more closed, electrically isolated connections.

17. The system of claim 11, further comprising:
one or more isolated input or output signal ports in the gateway interface for coupling to one or more call switches.

18. The system of claim 11, wherein the gateway interface communicates with the one or more call switches through a wireless communications medium.

19. The system of claim 11, wherein the gateway interface communicates with the IP network through a wireless communications medium.

20. The system of claim 11, wherein the gateway interface communicates with the microphone through a wireless communications medium.
